(19) United States
(12) Patent Application Publication
(10) Pub. No.: US 2012/0196532 A1
(43) Pub. Date: Aug. 2, 2012

(54) WIRELESS COMMUNICATION APPARATUS AND COMMUNICATION CONTROL METHOD

(76) Inventor: Ichiro Tomoda, Hamura-shi (JP)

(21) Appl. No.: 13/350,441

(22) Filed: Jan. 13, 2012

(30) Foreign Application Priority Data
Jan. 31, 2011 (JP) 2011-019227

(51) Int. Cl. H04B 5/00; H04W 88/00

(52) U.S. Cl. 455/41.1

(57) ABSTRACT

According to one embodiment, a wireless communication apparatus includes: a wireless communicator configured to perform near field communication with a target communication appliance; a direction detector configured to detect a direction in which the wireless communicator is placed; a calculator configured to calculate the difference between this direction and a direction in which the target communication appliance is placed according to the result obtained by communication regarding the direction with the target communication appliance; and a storage configured to store the difference between the directions at the time of near field communication and an application program to be used for the near field communication while a correspondence is made therebetween, wherein the wireless communicator performs near field communication with the target communication appliance using the application program depending on the difference between the directions calculated by the calculator.

### CROSS REFERENCE TO RELATED APPLICATION(S)

The application is based upon and claims the benefit of priority from Japanese Patent Application No. 2011-019227 filed on Jan. 31, 2011, the entire contents of which are incorporated herein by reference.

### BACKGROUND

1. Field

An embodiment according to the present invention relates to a wireless communication apparatus and a communication control method.

2. Description of the Related Art

In recent years, near field communication using a UWB (ultra-wide band) system has become wide spread and it has become possible to transmit and receive large amounts of data at high speed. TransferJet (registered trademark) serving as a near field communication system based on the UWB technology features simple data transfer as its concept by virtue of “touch & get” that utilizes a high communication speed (375 Mbps).

For example, in the field of wireless communication apparatuses, a technology is disclosed in which a mobile device is connected to a host device by a near field communication system (TransferJet), the relative direction between the mobile device and the host device is detected using the direction detection section of the mobile device, and an application is executed on the basis of the relative direction.

In this technology, each appliance individually detects its direction and controls service. However, it is demanded that the direction information of two communication appliances is superimposed on a communication message (more specifically, the appliance information message of TransferJet) and exchanged and that service is controlled on the basis of the difference in the direction information.

### BRIEF DESCRIPTION OF THE DRAWINGS

A general configuration that implements the various features of embodiments will be described with reference to the drawings. The drawings and the associated descriptions are provided to illustrate embodiments and not to limit the scope of the embodiments.

FIG. 1 is a functional block diagram of a notebook PC according to an embodiment of the present invention;

FIG. 2 is a functional block diagram of a mobile phone according to the embodiment;

FIG. 3 is a flowchart illustrating the operation of the service controller of the notebook PC according to the embodiment;

FIG. 4 is a view showing an example of the display of a dialog according to the embodiment;

FIG. 5 is a flowchart illustrating the operation of the service controller of the mobile phone according to the embodiment;

FIG. 6 is a view illustrating a type of usage according to the embodiment:

FIG. 7 is a view illustrating another type of usage according to the embodiment:

FIG. 8 is a view illustrating still another type of usage according to the embodiment:

FIG. 9 is a block diagram showing a configuration of a near field communication system according to the embodiment; and

FIG. 10 is a view showing an example of software architecture applied to control the near field communication applied to electronic appliances according to the embodiment.

### DETAILED DESCRIPTION

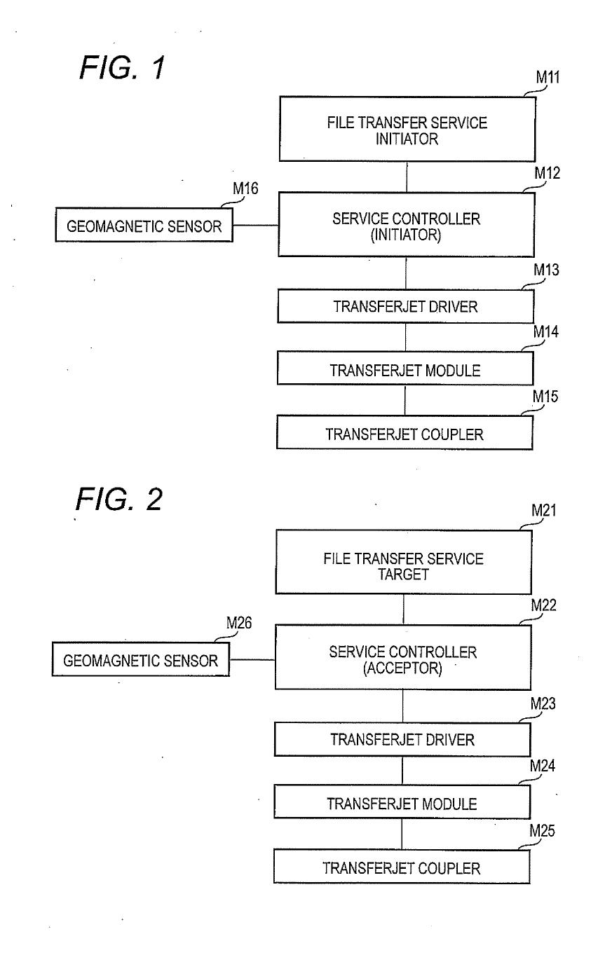

An embodiment according to the present invention will be described below referring to FIGS. 1 to 10.

First, for the purpose of accomplishing Touch & Get, it is basically demanded that a certain level of alignment is obtained at the time of touching and that communication is established by touching and broken by detaching. For the purpose of accomplishing these functions, a special antenna (coupler) is used for communication in TransferJet. This coupler uses an inductive electric field instead of a radiated electromagnetic field that is used for ordinary wireless communication. The coupler of TransferJet can be approximated to an infinitesimal dipole when represented by a view showing an electromagnetic field.

The wave of this infinitesimal dipole has a longitudinal wave component and a transverse wave component and divided into an electric field and a magnetic field. A radiated electromagnetic field selected from these has been used for conventional general wireless communication. Furthermore, a quasi-static electromagnetic field is available. However, TransferJet uses an inductive eclectic field selected from these, that is, a longitudinal wave component (θ=0°) in an inductive electromagnetic field (see Expression 1).

$$\begin{matrix}[ Mathematical expression 1 ] & \\ \text{?} = \frac{p {e}^{- j kR}}{2 π ɛ} ( \frac{1}{{R}^{3}} + \frac{jk}{{R}^{2}} ) cos θ \\ \text{?} \text{indicates text missing or illegible when filed} & ( 1 )\end{matrix}$$

The energy of this inductive electric field attenuates in inverse proportion to the fourth power of the distance (the intensity of the electric field attenuates in inverse proportion to the square of the distance).

On the other hand, the energy of the radiated electromagnetic field attenuates in inverse proportion to the square of the distance. In other words, the electric power in the case of TransferJet attenuates more sharply than that in the case of the conventional wireless communication. Hence, the feature that communication is broken by slight detaching can be accomplished easily. In a near distance, the electric power of the inductive electromagnetic field is larger than that of the radiated electromagnetic field, whereby “clear and crisp communication” can be accomplished. Furthermore, since the inductive electric field having only the longitudinal wave component is used, its strength against deviation is higher than that in the transverse wave component having a polarization plane, etc. Hence, stable communication is attained regardless of the direction of the connection, and this feature is favorable for “Touch & Get.” However, since the electric power of the inductive electric field attenuates sharply, the use of the inductive electric field has an aspect of being sensitive to the positional deviation of the touching operation.

TransferJet communication between a mobile phone and a notebook PC will be described below as an example of this embodiment.

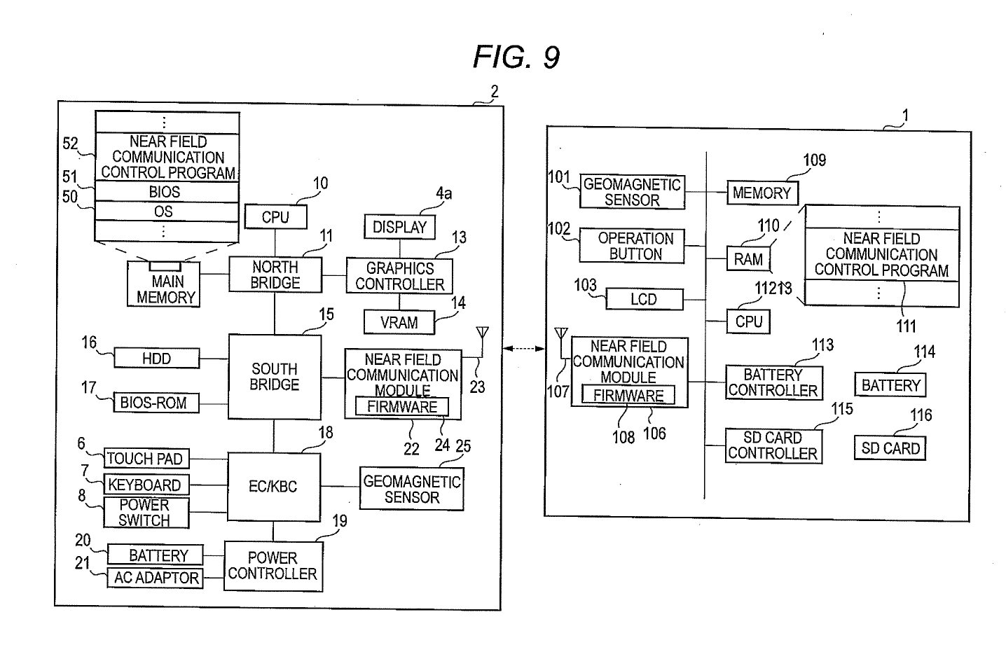

First, the functions of a mobile phone 1 and a personal computer 2 will be described below referring to FIG. 9.

FIG. 9 is a block diagram showing a configuration of a near field communication system according to the embodiment.

The mobile phone 1 is equipped with a geomagnetic sensor 101, an operation button 102, an LCD 103, a read/write function selection switch 105, a near field communication module 106, a memory 109, a RAM 110, a CPU 112, a battery controller 113, a battery 114, an SD card controller 115, and an SD card 116. The near field communication module 106 is equipped with a near field communication antenna 107 and a near field communication firmware 108.

The geomagnetic sensor 101 is an electronic compass described later. The operation button 102 is used to issue various processing instructions when photographed images are displayed. The LCD 103 displays photographed image data, for example. An SD card slot 104 is a slot provided to accommodate an SD card to which image data is copied. The near field communication module 106 performs near field communication with an external device. When a data read/write instruction is issued, the near field communication module 106 reads/writes data according to selected read/write control information.

The near field communication module 106 transmits/receives data to/from an external device via a wireless signal that uses an inductive electric field. In the case that the external device is moved close to the module and located within a communicatable distance (for example, 3 cm), the near field communication antenna 107 is coupled to the near field communication antenna of the external device by the inductive electric field, and wireless communication can be performed therebetween. The near field communication module 106 converts the wireless signal received at the near field communication antenna 107 into a digital signal, converts a digital signal to be used for internal control into a wireless signal, and transmits the wireless signal from the near field communication antenna 107.

The near field communication firmware 108 is used to add, for example, read/write function control information, to a predetermined area of a request message or a response message that is used for the processing of establishing PCL communication. In this embodiment, it is assumed that the area to be used is determined to be, for example, an area in an empty area (reserved area) of the request message or the response message according to the related standard.

The memory 109 is a storage medium provided for the mobile phone 1 and stores photographed still image data and moving image data. The RAM 110 is a so-called working memory into which various application programs are loaded. In this embodiment, a near field communication control program 111 is loaded. The CPU 112 is a control section for controlling the entire configuration of the mobile phone 1.

The battery controller 113 generates system power to be supplied to the respective components of the mobile phone using the battery 114. The SD card controller 115 accesses the SD card 116 to be mounted, moves and copies stored image data, and outputs the image data to the LCD 103.

The personal computer 2 is equipped with a display 4a, a touch pad 6, a keyboard 7, a power switch 8, a CPU 10, a north bridge 11, a main memory 12, a graphics controller 13, a VRAM 14, a south bridge 15, an HDD 16, a BIOS-ROM 17, an EC/KBC 18, a power controller 19, a battery 20, an AC adaptor 21, a near field communication module 22, and a geomagnetic sensor 25. The near field communication module is equipped with a near field communication antenna 23 and a near field communication firmware 24.

The CPU 10 is a processor provided to control the operation of the personal computer 2 and executes an operating system (OS 50) and various application programs loaded from the HDD 16 into the main memory 12. Furthermore, the CPU 10 loads the system BIOS 51 stored in the BIOS-ROM 17 into the main memory 12 and executes the system BIOS 51. The system BIOS 51 serves as programs for hardware control. Moreover, the CPU 10 executes a near field communication control program 52 and controls near field communication performed in the near field communication module 23.

The north bridge 11 is a bridge device for connecting the local bus of the CPU 10 to the south bridge 15. A memory controller for accessing and controlling the main memory 12 is built in the north bridge 11. Furthermore, the north bridge 11 is further equipped with a function for performing communication with the graphics controller 13 via an AGP (accelerated graphics port) bus or the like.

The main memory 12 is a so-called working memory into which the operating system (OS 50) and various application programs stored in the HDD 16 and the system BIOS 51 stored in the BIOS-ROM 17 are loaded.

The graphics controller 13 is a display controller for controlling the display 4a that is used as the display monitor of this computer. The graphics controller 13 generates a video signal for forming a display image to be displayed on the display 4a from display data drawn in the VRAM 14 by an application program.

The south bridge 15 accesses the BIOS-ROM 17 and controls disk drives (I/O devices), such as the HDD 16 and an ODD (optical disk drive).

The HDD 16 is a storage device for storing the OS 50, various application programs, etc. For example, the HDD 16 stores image data received via near field communication performed by the near field communication module 22.

The BIOS-ROM 17 is a rewritable nonvolatile memory for storing the system BIOS 51 serving as programs for hardware control.

The EC/KBC 18 controls the touch pad 6 and the keyboard 7 serving as input means. The EC/KBC 18 is a one-chip microcomputer for monitoring and controlling various devices (peripheral appliances, sensors, power circuits, etc.) regardless of the system state of the personal computer 2. Furthermore, the EC/KBC 18 has a function of turning on/off the power of the personal computer 2 in cooperation with the power controller 19 in response to the operation of the power switch 8 by the user.

In the case that external power is supplied via the AC adaptor 21, the power controller 19 generates system power to be supplied to the respective components of the personal computer 2 using the external power supplied from the AC adaptor 21. Furthermore, in the case that no external power is supplied via the AC adaptor 21, the power controller 19 generates system power to be supplied to the respective components (the main body 3 and the display unit 4 of the computer) of the personal computer 2 using the battery 20.

The near field communication module 22 transmits/receives data to/from an external device via a wireless signal that uses an inductive electric field. In the case that the external device is moved close to the module and located within a communicatable distance (for example, 3 cm), the near field communication antenna 23 is coupled to the near field communication antenna of the external device by the inductive electric field, and wireless communication can be performed therebetween. The near field communication module 22 converts the wireless signal transmitted/received via the near field communication antenna 23 into a digital signal and transmits the digital signal to the inside.

The near field communication firmware 24 is used to add, for example, read/write function control information, to an empty area, etc. of a request message or a response message that is used for the processing of establishing PCL communication.

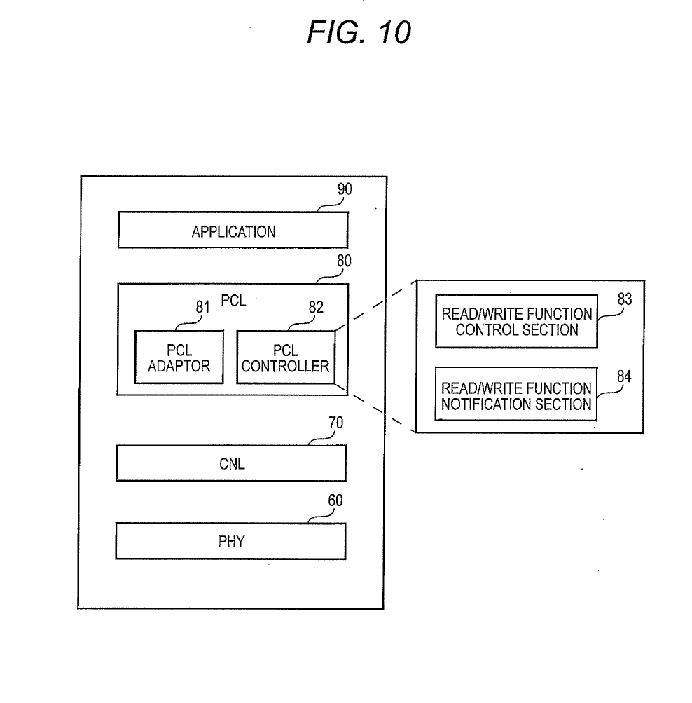

Next, software architecture for controlling near field communication according to this embodiment will be described below referring to FIG. 10. FIG. 10 is a view showing an example of software architecture applied to control the near field communication applied to the electronic appliances according to this embodiment.

The software architecture of FIG. 10 shows the hierarchical structure of a protocol stack for controlling near field communication. The protocol stack consists of a physical layer (PHY) 60, a connection layer (CNL) 70, a protocol conversion layer (PCL) 80, and an application layer 90. For example, the connection layer (CNL) 70, the protocol conversion layer (PCL) 80 and the application layer 90 are accomplished by the near field communication firmware 24 and the near field communication control program 52.

The physical layer (PRY) 60 is a layer for controlling physical data transmission and corresponds to the physical layer inside an OSI reference model. Part or all of the functions of the physical layer (PHY) 60 can also be accomplished using the hardware inside the near field communication module 22.

The physical layer (PHY) 60 converts the data from the connection layer (CNL) 70 into a wireless signal. The connection layer (CNL) 70 corresponds to the data link layer and the transport layer inside the OSI reference model and controls the physical layer (PHY) 60 to perform data communication.

The connection layer (CNL) 70 performs processing for establishing connection (CNL connection) with an external device being in a near field communication state according to a connection request from the protocol conversion layer (PCL) 80 or a connection request from the external device.

The protocol conversion layer (PCL) 80 corresponds to the session layer and the presentation layer provided inside the OSI reference model and is positioned between the application layer 90 and the connection layer (CNL) 70 for controlling the establishment and cancellation of the connection between the devices. The protocol conversion layer (PCL) 80 controls the connection layer (CNL) 70 according to instructions from applications (communication programs) inside the application layer 90.

More specifically, the protocol conversion layer (PCL) 80 has a plurality of communication adaptors (PCL adaptors 81) corresponding to application protocols (for example, SCSI, OBEX and other general-purpose protocols) used by respective communication programs of the application layer and also has a PCL controller 82 for controlling the operation of the protocol conversion layer (PCL) 80.

The PCL adaptor 81 performs conversion processing for converting data (user data) into a specific transmission data format. With this conversion processing, data transmitted/received by any communication program can be converted into packets (data in the specific transmission data format) that can be processed by the connection layer (CNL) 70. The protocol conversion layer (PCL) 80 allows various application protocols to be used for near field communication.

The PCL controller 82 performs processing for exchanging service information (information representing service that can be provided by each device) and session information (information regarding sessions for establishment/disconnection), the start of applications, the management of connections, the management of sessions, etc. between the PCL controller 82 and the device of the other party of communication.

Furthermore, the PCL controller 82 is equipped with a read/write function control section 83 and a read/write function notification section 84.

The read/write function control section 83 adds the read/write function control information to the empty area of the request message or the response message that is used for the processing of establishing PCL communication.

In the case that a data reading instruction or a data writing instruction is issued from an application after the PCL communication is established, the read/write function notification section 84 transmits read/write control information, etc. set by the read/write function control section 83 to the application. For example, in the case it is prohibited to write data in a storage medium provided for the apparatus, the read/write function notification section 84 informs to the device of the other party of communication that data writing is prohibited.

The application layer 90 includes a plurality of communication programs (applications) corresponding to some application protocols, such as SCSI, OBEX and other general-purpose protocols. Each application performs processing for requesting the start/end of a session to the protocol conversion layer (PCL) 80 and performs processing for data transmission/reception via the protocol conversion layer (PCL) 80.

FIG. 1 is a functional block diagram of the notebook PC and FIG. 2 is a functional block diagram of the mobile phone (only the blocks closely relating to this embodiment are shown in both the block diagrams). The block of the service controller shown in each block diagram has features based on the concept of this embodiment. The components other than the service controller are similar to those of a general TransferJet appliance.

A file transfer service initiator M11 and a service controller M12 belong to the application layer 90, and a TransferJet driver M13 belongs to the protocol conversion layer (PCL) 80. Furthermore, a TransferJet module M14 belongs to the connection layer 70, and the TransferJet coupler M15 belongs to the physical layer 60.

A geomagnetic sensor M16 corresponds to the geomagnetic sensor 25.

Moreover, a file transfer service target M21 and a service controller M22 belong to the application layer 90, and a TransferJet driver M23 belongs to the protocol conversion layer 80. Furthermore, a TransferJet module M24 belongs to the connection layer 70, and a TransferJet coupler M25 belongs to the physical layer 60. A geomagnetic sensor M26 corresponds to the geomagnetic sensor 101.

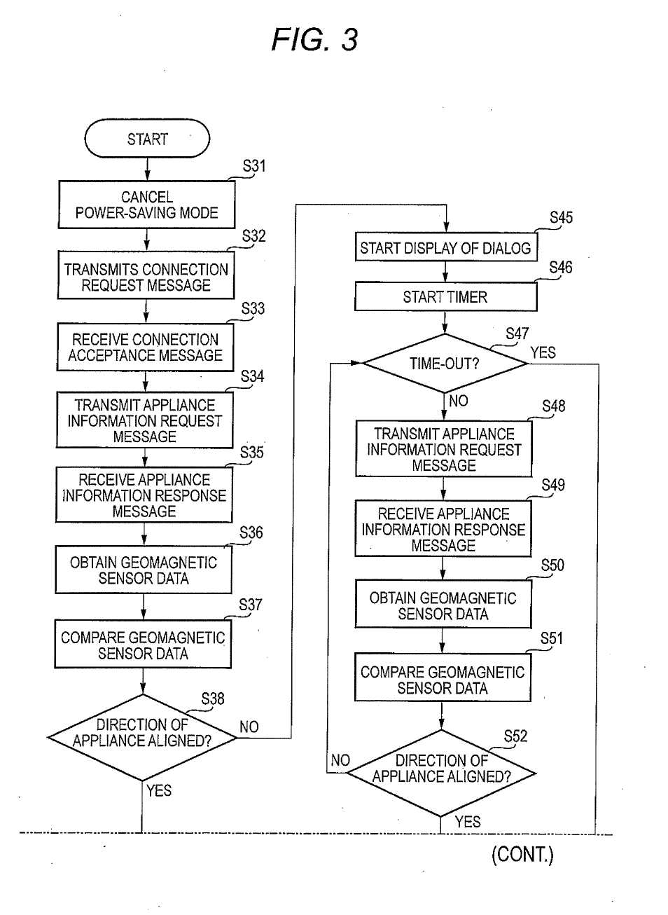

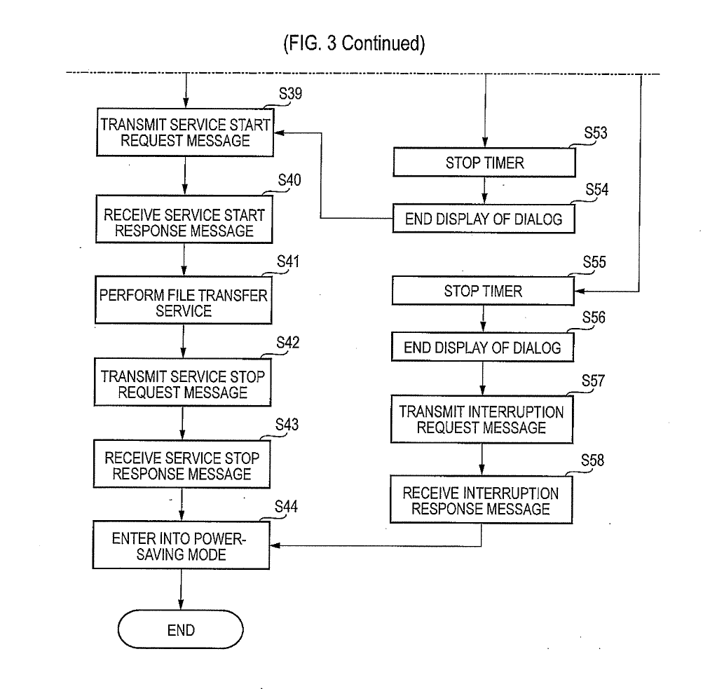

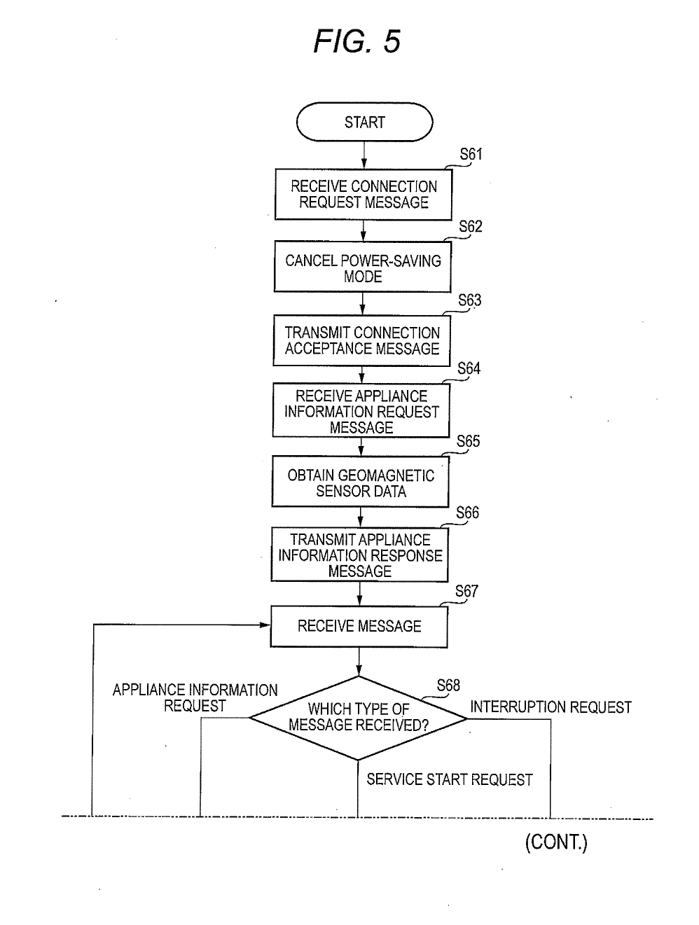

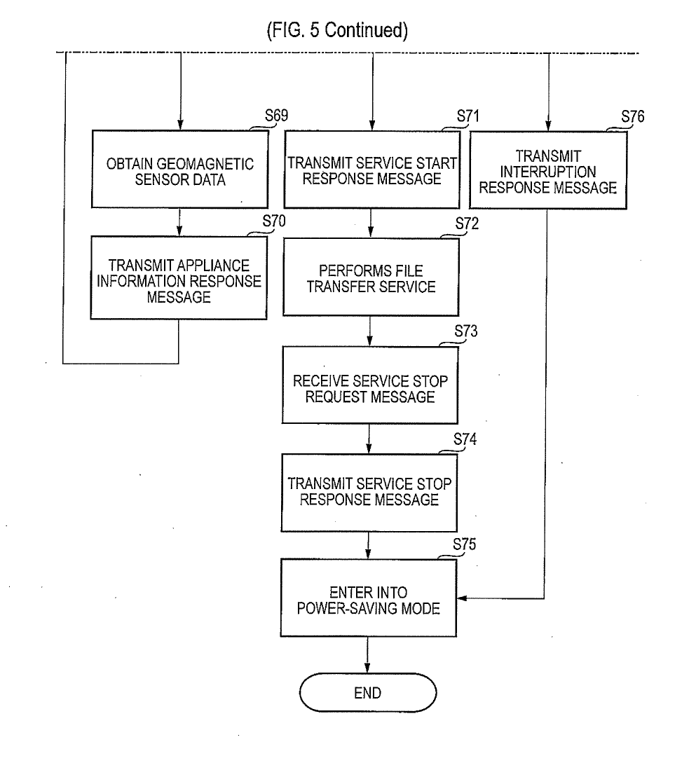

FIG. 3 is a flowchart illustrating the operation of the service controller M12 of the notebook PC 2, and FIG. 5 is a flowchart illustrating the operation of the service controller M22 of a mobile phone 1.

First, the notebook PC 2 cancels the power-saving mode (at step S31), and transmits a connection request message to the mobile phone 1 (at step S32).

Upon receiving the connection request message from the notebook PC 2 (at step S61), the mobile phone 1 cancels the power-saving mode (at step S62) and transmits a connection acceptance message to the notebook PC 2 (at step S63).

Upon receiving the connection acceptance message from the mobile phone 1 (at step S33), the notebook PC 2 transmits an appliance information request message to the mobile phone 1 (at step S34).

Upon receiving the appliance information request message from the notebook PC 2 (at step S64), the mobile phone 1 obtains data from the geomagnetic sensor M26 (electronic compass) (at step S65) and transmits an appliance information response message on which the data is superimposed to the notebook PC 2 (at step S66).

Upon receiving the appliance information response message from the mobile phone 1 (at step S35), the notebook PC 2 obtains the data, superimposed on the message, of the geomagnetic sensor M26 of the mobile phone 1 (at step S36). Furthermore, the notebook PC 2 obtains the data of the geomagnetic sensor M16 thereof (at step S36). Then, the notebook PC 2 obtains the difference between the data of the two geomagnetic sensors (at step S37).

During this time, the mobile phone 1 receives a message (at step S67), obtains the data of the geomagnetic sensor M26 thereof (at step S69) and transmits this data to the notebook PC 2 (at step S70).

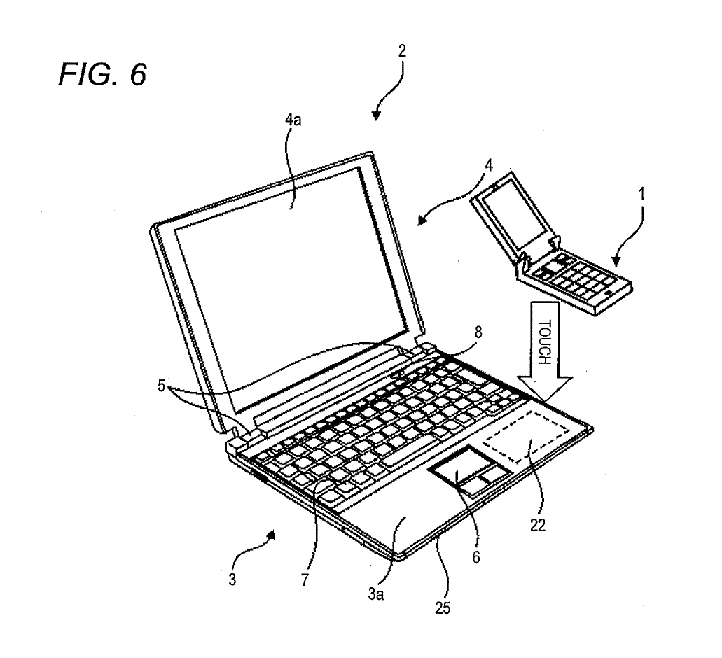

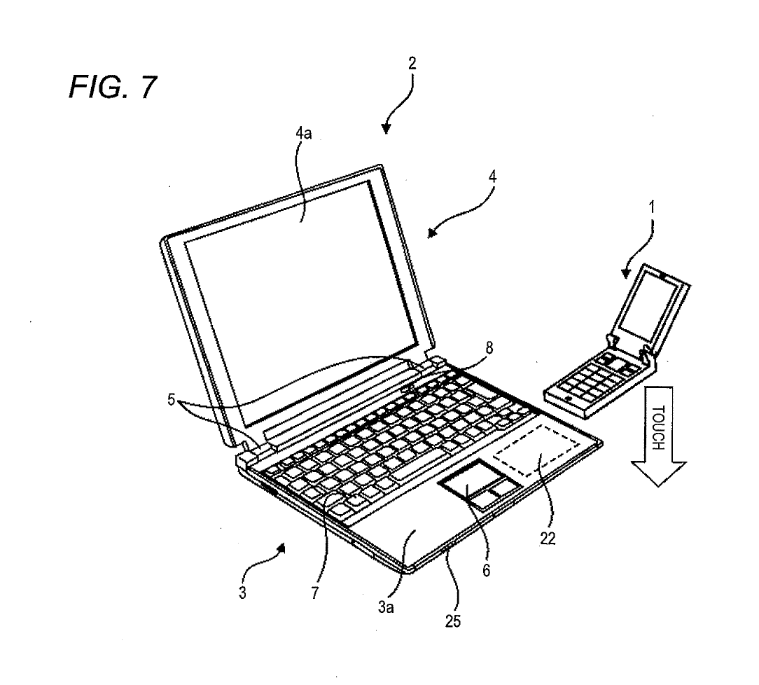

In the case that the difference between the data of the two geomagnetic sensors is in the range of 0±5°, 180±5°, 90±5° or 270±5° (in a state in which the mobile phone 1 is aligned so as to be longitudinal or transverse to the notebook PC 2 as shown in FIGS. 6 and 7) (YES at step S38), the notebook PC 2 enters into service start processing (at step S39 and the following steps).

The notebook PC 2 transmits a service start request message to the mobile phone 1 (at step S39).

Upon receiving the service start request message from the notebook PC 2 (at steps S67 and S68), the mobile phone 1 transmits a service start response message to the notebook PC 2 (at step S71).

Upon receiving service start response message from the mobile phone 1 (at step S40), the notebook PC 2 performs file transfer service (at step S41). Furthermore, in response to this, the mobile phone 1 also performs file transfer service (at step S72).

After this file transfer service is completed, the notebook PC 2 transmits a service stop request message to the mobile phone 1 (at step S42).

Upon receiving the service stop request message from the notebook PC 2 (at step S73), the mobile phone 1 transmits a service stop response message to the notebook PC 2 (at step S74).

Upon receiving the service stop response message from the mobile phone 1 (at step S43), the notebook PC 2 enters into the power-saving mode (at step S44), thereby completing the series of processing. The mobile phone 1 also enters into the power-saving mode, thereby completing the series of processing.

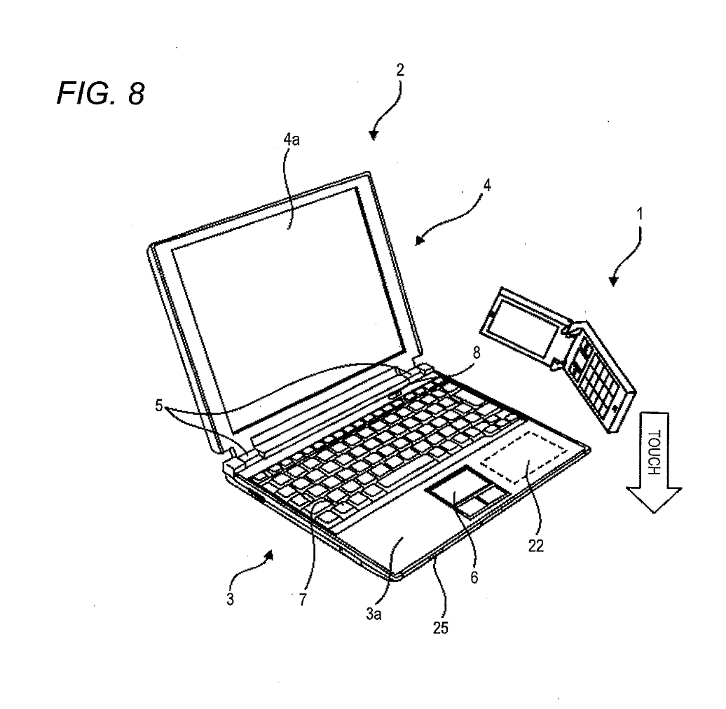

In the case that the difference between the data of the two geomagnetic sensors described above is not in the above-mentioned range (in a state in which the direction of the mobile phone 1 is not aligned with the direction of the notebook PC 2 as shown in FIG. 8) (NO at step S38), the notebook PC 2 performs the following processing.

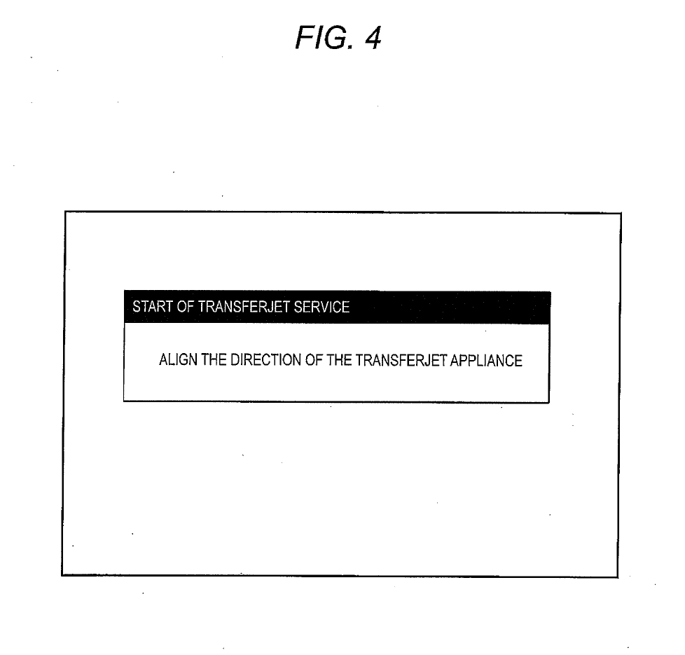

First, the notebook PC 2 displays a dialog on the display 4a as shown in FIG. 4 to prompt the user to align the direction of the appliance (at step S45).

Next, the notebook PC 2 starts a timer for measuring a time-out time (at step S46).

Until the time-out time is reached (NO at step S47), the following steps are repeated (NO at step S52). The notebook PC 2 transmits an appliance information request message (at step S48), obtains the difference between the data of the two geomagnetic sensors (at steps S49, S50 and S51), and judges whether the direction of the appliance is aligned (at step S52).

If the direction of the appliance is aligned before the time-out time is reached (YES at step S52), the notebook PC 2 stops the timer (at step S53), ends the display of the dialog (at step S54) and then enters into service start processing (at step S39 and the following steps).

If the time-out time has passed (YES at step S47), the notebook PC 2 enters into interruption processing and then enters into the power-saving mode (at step S55 and the following steps).

More specifically, first, the notebook PC 2 stops the timer (at step S55) and ends the display of the dialog (at step S56). Next, the notebook PC 2 transmits an interruption request message to the mobile phone 1 (at step S57).

Upon receiving the interruption request message from the notebook PC 2 (at step S76), the mobile phone 1 transmits an interruption response message to the notebook PC 2 (at step S76), and the procedure advances to step S75).

In the case that the appliance can execute plural types of service, it is possible to select a different type of service depending on the difference between the data of the two geomagnetic sensors.

For example, in the case that the appliance supports two types of service, i.e., file transfer service and synchronization service, it becomes possible that the file transfer service is started in the case that the difference between the data of the two geomagnetic sensors is in the range of 0±5° or 180±5°, and the synchronization service is started in the case that the difference is in the range of 90±5° or 270±5°.

Generally speaking, when the user touches an appliance to another appliance, the user often aligns the direction of the one appliance with the direction of the other appliance according to the psychology of the user. Conversely, in the case that the one appliance is touched to the other appliance in a state in which their directions are not aligned with each other, it is highly possible that the touch is not intended by the user. With this embodiment, it is possible to decrease the probability that service is started by the unintended touch of the user.

The outline of a TransferJet service control method using electronic compasses is described above in which a communication system based on non-contact communication (TransferJet) consists of a PC and a mobile phone, an electronic compass (geomagnetic sensor) is provided for each appliance, an initiator receives the direction of one appliance measured by an electronic compass from a responder at the time of connection, compares the direction with the direction of the other appliance incorporating the initiator and determines service to be started according to the difference between the directions of the two appliances. The direction information of the two communication appliances is superimposed on a communication message (more specifically, the appliance information message of TransferJet) and exchanged, the difference between the directions of the two appliances (the difference in direction) is calculated, and the service is controlled on the basis of the difference.

When an appliance is touched to another appliance using TransferJet, the difference between the directions of the two appliances is measured according to the data of the electronic compasses (geomagnetic sensors). In the case that the directions of the two appliances are not aligned with each other, no service is started.

The present invention is not limited to the above-mentioned embodiment, but can be modified variously without departing from the spirit of the invention. For example, the above-mentioned application programs are not limited to those stored in the mobile phone 1 or the personal computer 2, but may be those obtained by so-called cloud computing.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a wireless communicator configured to perform near field communication with a target communication appliance;
a direction detector configured to detect a direction in which the wireless communicator is placed;
a calculator configured to calculate the difference between this direction and a direction in which the target communication appliance is placed according to the result obtained by communication regarding the direction with the target communication appliance; and
a storage configured to store the difference between the directions at the time of near field communication and an application program to be used for the near field communication while a correspondence is made therebetween, wherein
the wireless communicator performs near field communication with the target communication appliance using the application program depending on the difference between the directions calculated by the calculator.

2. The wireless communication apparatus according to claim 1, wherein
the storage stores the differences between a plurality of directions in which the wireless communicator can take and a plurality of application programs to be used for the near field communication while a correspondence is made therebetween.

3. The wireless communication apparatus according to claim 1, wherein
the direction detector detects the direction of the wireless communication apparatus by detecting the direction of gravitational force.

4. The wireless communication apparatus according to claim 1, wherein
the near field communication conforms to the TransferJet system.

5. The wireless communication apparatus according to claim 4, wherein
the near field communication uses OBEX or SCSI.

6. The wireless communication apparatus according to claim 2, wherein
the plurality of application programs include synchronization service.

7. A communication control method for performing near field communication between a wireless communication apparatus and a target communication appliance, comprising:
detecting a direction in which the wireless communication apparatus is placed;
calculating the difference between this direction and a direction in which the target communication appliance is placed according to the result obtained by communication regarding the direction with the target communication appliance;
using a storage that is incorporated in the wireless communication apparatus and preliminarily stores the difference between the directions and an application program to be used for the near field communication while a correspondence is made therebetween at the time of near field communication; and
performing near field communication with the target communication appliance using the application program depending on the calculated difference between the directions.
